(19) United States
(12) Patent Application Publication
(10) Pub. No.: US 2019/0226592 A1
(43) Pub. Date: Jul. 25, 2019

(54) DOUBLE BLOCK AND BLEED VALVE WITH FLEX BYPASS FOR EFFECTIVE AND EFFICIENT SYSTEM ISOLATION

(71) Applicant: Honeywell International Inc., Morris Plains, NJ (US)

(72) Inventors: Taher Hussein, Mount Prospect, IL (US); Drew D. Martin, Gonzales, LA (US)

(73) Assignee: Honeywell International Inc.

(21) Appl. No.: 15/879,698

(22) Filed: Jan. 25, 2018

(51) Int. Cl. F16K 15/04; F16K 1/44; F16K 11/056; F16K 24/02; F16K 5/06

(52) U.S. Cl. CPC F16K 15/048; F16K 1/446; F16K 5/0605; F16K 24/02; F16K 11/056

(57) ABSTRACT

A valve apparatus for use in industrial plants and systems. The valve apparatus can a first ball valve, a second ball valve, a third ball valve, and a fourth ball valve disposed between first and second blocks. A bleed valve assembly is disposed between the first ball valve and the second ball valve, and the fourth ball valve is disposed between the second and third ball valves. The bleed valve assembly is configured with threads or a cam lock for connection to a flex hose. The bleed valve assembly can include a globe valve. The valve apparatus can be implemented as a DBB (Double-Block and Bleed) valve assembly that includes the first, second, third, and fourth ball valves. The fourth ball valve disposed between the second and third ball valves can function as an extra bleed valve.

### TECHNICAL FIELD

Embodiments are generally related to valves and more particularly to gas valve assemblies. Embodiments further relate to block valves for regulating fluid through a fluid system and more particularly a block valve with a pressure and fluid bleed feature. Embodiments also relate to DBB (Double-Block and Bleed) valves and assemblies.

### BACKGROUND

Industrial fluid delivery systems routinely include one or more fluid valves configured to control the rate of, or completely terminate, fluid flow through the system. Block-and-bleed valves are used to isolate or block the flow of fluid in such a system, so the fluid from upstream of the valve does not reach other components of the system that are downstream, then bleed off or vent the remaining fluid from the system on the downstream side of the valve. A DBB (Double-block-and bleed) valve system operates on the principle that isolation can be achieved from both the upstream and downstream process flow/pressures. Typically, to provide a DBB system, two control or stop valves are used in series with a third vent valve positioned between them. When the two control and/or stop valves are closed, the vent valve can be opened to relieve any residual pressure and/or leakage.

In many industrial plants, DBB valves are a requirement for isolating equipment and systems in order to perform work on such systems. DBB valves and assemblies offer an important safety element in industrial plant operations, because DBB configurations and assemblies are used in high pressure and/or high temperature systems and hazardous/toxic chemical services. In order to prevent plants from shutting down while instruments or valves are being serviced, bypasses are typically installed around the targeted equipment in order to avoid shutdowns.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for an improved valve assembly.

It is another aspect of the disclosed embodiments to provide for improved block valves for regulating fluid through a fluid system and more particularly a block valve with at least a fluid bleed feature.

It is yet another aspect of the disclosed embodiments to provide for an improved DBB valve assembly.

It is still another aspect of the disclosed embodiments to provide for a DBB valve assembly with a flex bypass for effective and efficient system isolation.

The aforementioned aspects and other objectives and advantages can now be achieved as described herein. A valve apparatus for use in industrial plants and systems is disclosed herein. In an example embodiment, the valve apparatus can include a first block and a second block. A first ball valve, a second ball valve, a third ball valve, and a fourth ball valve are disposed between the first and second blocks. A bleed valve assembly is disposed between the first ball valve and the second ball valve, and the fourth ball valve is disposed between the second and third ball valves. The bleed valve assembly can be configured with threads for connection to a flex hose or, alternatively, with a cam lock connection. The bleed valve assembly can include a globe valve. The valve apparatus can be implemented as a DBB (Double-Block and Bleed) valve assembly that includes the first, second, third, and fourth ball valves. The fourth ball valve disposed between the second and third ball valves can function as an extra bleed valve.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a schematic diagram of a valve apparatus for a fluid delivery system, which can be implemented in accordance with an example embodiment;

FIG. 2 illustrates a schematic diagram of a valve apparatus for a fluid delivery system that includes a cam lock connection, in accordance with an alternative embodiment; and

FIG. 3 illustrates a schematic diagram depicting an example use of a valve apparatus, in accordance with another example embodiment.

### DETAILED DESCRIPTION

The particular values and configurations discussed in these non-limiting examples can be varied and are cited merely to illustrate at least one embodiment and are not intended to limit the scope thereof.

The embodiments will now be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete, and will fully convey the scope of the embodiments to those skilled in the art. As used herein, the term “and/or” includes any and all combinations of one or more of the associated listed items.

Reference will be made in detail to the disclosed embodiments (exemplary embodiments) of the invention, examples of which are illustrated in the accompanying drawings, and which may be preferred or alternative embodiments. In the following description, reference is made to the accompanying drawings that form a part thereof, and in which is shown by way of illustration specific exemplary embodiments in which the invention may be practiced. These embodiments are described in sufficient detail to enable those skilled in the art to practice the invention and it is to be understood that other embodiments may be utilized and that changes may be made without departing from the scope of the invention. The following description is, therefore, merely exemplary.

While the invention has been illustrated with respect to one or more implementations, alterations and/or modifications can be made to the illustrated examples without departing from the spirit and scope of the appended claims. In addition, while a particular feature of the invention may have been disclosed with respect to only one of several implementations, such feature may be combined with one or more other features of the other implementations as may be desired and advantageous for any given or particular function. Furthermore, to the extent that the terms “including,” “includes,” “having,” “has,” “with,” or variants thereof are used in either the detailed description and the claims, such terms are intended to be inclusive in a manner similar to the term “comprising.” The term “at least one” of is used to mean one or more of the listed items can be selected.

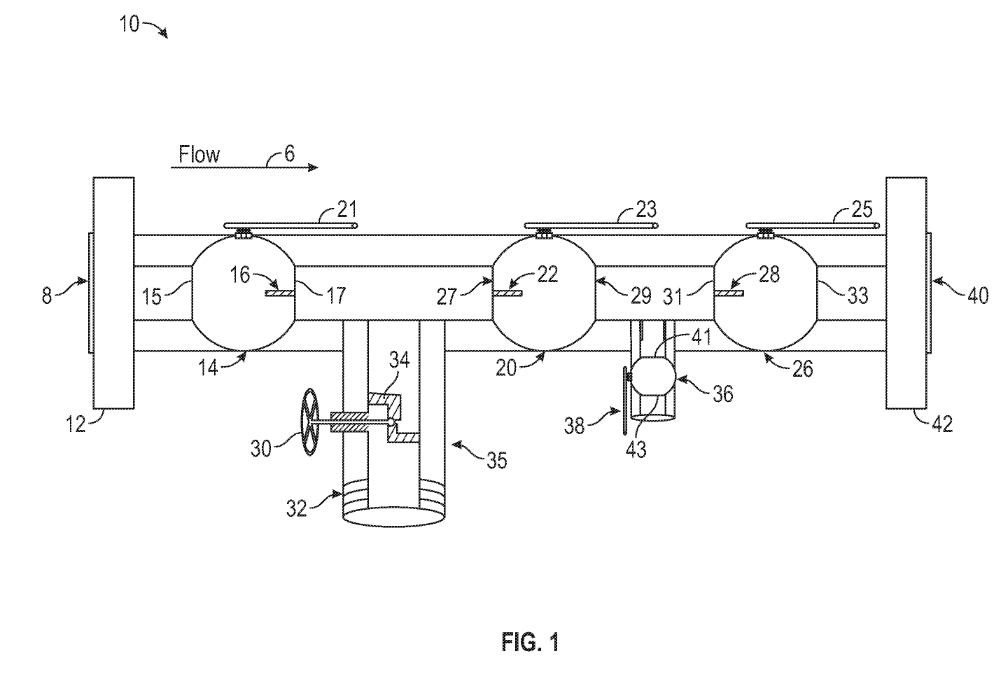

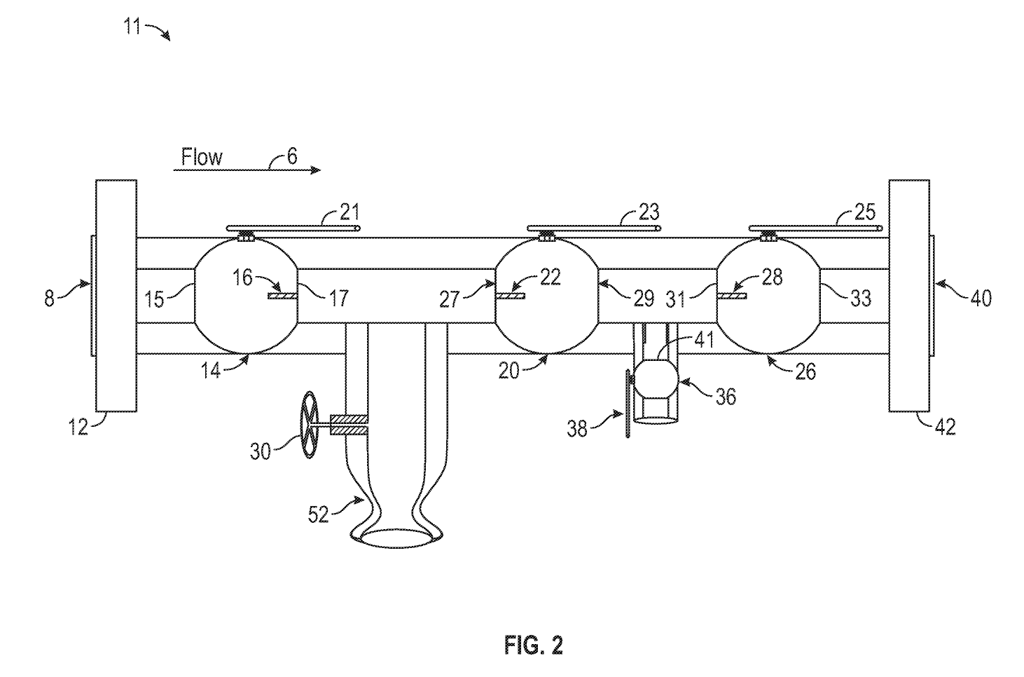

FIG. 1 illustrates a schematic diagram of a valve apparatus 10 for a fluid delivery system, which can be implemented in accordance with an example embodiment. Note that as utilized herein, the term “fluid” can refer to a gas or a liquid. In FIG. 1, fluid flow is indicated by arrow 6, which generally indicates a flow of fluid from the left side of FIG. 1 to the right side of FIG. 1. The valve apparatus 10 includes a plurality of valves, including a group of ball valves 14, 20, 26, 36 and a bleed valve assembly 35 (i.e., a bleed valve) composed of at least a globe valve 30 that engages an internal passage 34. NPT (National Pipe Threads) threads 32 (or, alternatively, a cam lock connection 52 as shown in FIG. 2) can be configured on the body of the bleed valve assembly 35. The bleed valve assembly 35 is disposed between blocks 12 and 42, which represent the object or objects being isolated. Gaskets 8 and 40 are also shown in FIG. 1. Since the valve apparatus 10 can be configured with a flanged valve arrangement, gaskets such as gaskets 8 and/or 40 may be required in some example embodiments to be inserted between the valve and piping flanges to provide a tight seal.

Each ball valve 14, 20, 26, and 36 contains one or more ball seals. For example, ball valve 14 contains ball seals 15 and 17. Ball valve 20 contains ball seals 27 and 29. Ball valve 26 contains ball seals 31 and 33. Ball valve 36 contains ball seals 41 and 43. Each ball valve 14, 20, 26, and 36 further contains an annular passage or vent. For example, ball valve 14 contains a vent 16. Ball valve 20 contains a vent 22. Ball valve 26, for example, can contain a vent 28. Each of the vents is directed away from the affected work area in the closed position to achieve the maximum safety aspect. Each ball valve 14, 20, 26, and 36 also includes a respective handle. Ball valve 14 includes a handle 21. Ball valve 20 includes a handle 23. Ball valve 26 includes a handle 25, and ball valve 36 includes a handle 38. In some example embodiments, the handles can be (but are not limited to) a quarter turn or wheel handles.

The valve assembly depicted in FIG. 1 can control the flow of fluids in the fluid delivery system 10. Each ball valve 14, 20, 26, and 36 includes a valve body having a fluid passageway therethrough. A ball or ball element is positioned within the valve body so as to be placed in the fluid passageway. Each ball in the ball valves 14, 20, 26, and 36 can contain its own fluid conduit extending therethrough and defining a flow path through each ball. When the conduit in the ball is aligned with the fluid passageway through the valve body, fluid may flow through the valve generally unimpeded. If the ball is rotated such that the ball conduit is out of alignment with the valve body passageway, then the flow is restricted.

Each ball valve 14, 20, 26, and 36 can be actuated or rotated through a stem (not shown) that passes through the valve body and attaches to the ball. A handle such as one or more of the handles 21, 23, 25, and/or 38 or some other means, such as a gear, may be attached to the opposite end of the stem in order to turn the stem. The amount of fluid passing through the ball valve changes as the ball rotates. A particular angular orientation of the ball corresponds to a particular degree of alignment between the conduit and the passageway, which in turn corresponds to the flow rate.

The valve apparatus 10 shown in FIG. 1 can function as a DBB valve assembly, albeit with a different and improved configuration than that of conventional DBB valve arrangements. For example, instead of being limited to only a two-valve arrangement, the valve apparatus 10 includes ball valves 14, 20, and 26 with the bleed valve assembly 35 disposed between the ball valves 14 and 20, and the ball assembly 36 disposed between ball valves 20 and 26. In the manner, the ball valve 36 can also a function as a bleed valve with respect to ball valves 20 and 26. This configuration provides a flexible bypass through the use of the bleed valve assembly 35 and the ball valve 36 (which can also function as a bleed valve). The valve apparatus 10 thus integrates a DBB configuration and a bypass through the implementation of an extra valve (e.g., the ball valve 36 or the valve assembly 35) that can be connected to, for example, a flex hose, which increases the flexibility of, for example, an industrial plant as a whole.

The valve apparatus 10 can be implemented in a module design to decrease the amount of spaces required because the valve apparatus 10 removes all the piping needed for bypasses and exchanges such piping with the use of, for example, flex hoses. Moreover, the design of valve apparatus 10 delivers the safety requirements of a DBB. By accomplishing a DBB configuration in a much smaller space, the valve apparatus 10 offers additional safety benefits because it contains a smaller volume of hazardous chemicals when closed. In addition, a safe condition can be attained more quickly by operators evacuating the space. Moreover, the NPT threaded connection (e.g., the NPT threads 32) can be utilized as a sampling point in some example embodiments.

FIG. 2 illustrates a schematic diagram of a valve apparatus 11 for a fluid delivery system that includes a cam lock connection, in accordance with an alternative embodiment. Note that in FIGS. 1-2, identical or similar parts or elements are generally indicated by identical reference numerals. Thus, the valve apparatus 11 depicted in FIG. 2 is similar to the valve apparatus 10 shown in FIG. 1, the difference being that the configuration depicted in FIG. 2 utilizes a cam-lock connection 52 instead of the threaded arrangement shown in FIG. 1 (i.e., the NPT threads 32). The cam-lock connection 52 can be either welded to the body of the DBB valve discussed herein in the shop or threaded to the FIG. 1 configuration through the aforementioned NPT. Note that the NPT location (inside or outside the DBB body) is not critical, however, both cases are covered via the disclosed embodiments.

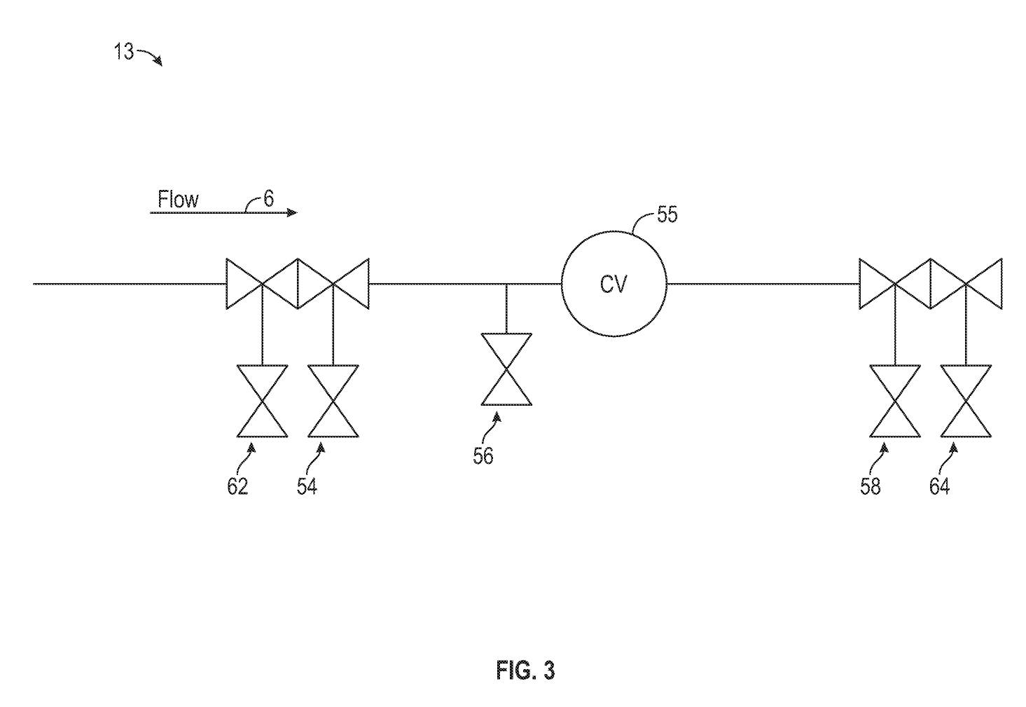

FIG. 3 illustrates a schematic diagram depicting an example use of a valve apparatus 13, in accordance with another embodiment. Directional flow is generally indicated in FIG. 3 by arrow 6. The valve apparatus 13 shown in FIG. 3 is preferably implemented in the context of a DBB valve configuration such as previously discussed herein. FIG. 3 thus shows a use of the disclosed DBB valve (or valves). The DBB valve can be installed on both sides of the system of interest (depicted in FIG. 3 as CV (Control Valve) 55) with a flex hose connection located away from the system and the bleed valve (or valves) located close to the system. Thus, in FIG. 3 a flex hose connection 62, a bleed valve 54, and another valve 56 are located to the left of CV 55. A bleed valve 58 and a flex hose connection 64 are located to the right of the CV 55 in the example valve apparatus 13 shown in FIG. 3. The bleed valves 54 and 58 shown in FIG. 3 can form the bleed valve assembly discussed herein. Note that the CV 55 is an example of system that can be isolated and can be, for example, a simple CV (e.g., pressure, temperature, or flow control valve), a vessel or a full unit. As indicated previously, the aforementioned DBB can be used for isolating such different types of systems/devices.

Based on the foregoing, the applicant submits that a number of example embodiments are disclosed herein. For example, in one embodiment, a valve apparatus can be implemented, which includes at least four ball valves including a first ball valve, a second ball valve, a third ball valve, and a fourth ball valve, wherein the first, second, third, and fourth ball valves are disposed between a first block and a second block; and a bleed valve assembly disposed between the first ball valve and the second ball valve, wherein the fourth ball valve is disposed between the second and third ball valves, and wherein the bleed valve assembly is configured for connection to a flex hose.

In another example embodiment, the aforementioned bleed valve assembly can include a globe valve having threads for connection to the flex hose. In some example embodiments, the bleed valve assembly can include a globe valve having a cam lock connection for connection to the flex hose. In another example embodiment, a DBB (Double-Block and Bleed) valve assembly can be configured, which includes the first, second, third, and fourth ball valves. In still another example embodiment, the fourth ball valve can be disposed between the second and third ball valves and can function as an extra bleed valve. Note that each of the first, second, third, and fourth ball valves can contain at least two ball seals. In another example embodiment, at least one gasket can be inserted between a valve and piping flanges to provide a tight seal.

In another example embodiment, a valve apparatus can be configured, which includes a first block and a second block; at least four ball valves including a first ball valve, a second ball valve, a third ball valve, and a fourth ball valve, wherein the first, second, third, and fourth ball valves are disposed between the first and second blocks; and a bleed valve assembly disposed between the first ball valve and the second ball valve, wherein the fourth ball valve is disposed between the second and third ball valves, and wherein the bleed valve assembly is configured with threads for connection to a flex hose.

In still another example embodiment, a valve apparatus can be configured, which includes a first block and a second block; at least four ball valves including a first ball valve, a second ball valve, a third ball valve, and a fourth ball valve, wherein the first, second, third, and fourth ball valves are disposed between the first and second blocks; and a bleed valve assembly disposed between the first ball valve and the second ball valve, wherein the fourth ball valve is disposed between the second and third ball valves, and wherein the bleed valve assembly is configured with a cam lock for connection to a flex hose.

The preceding description of the disclosed embodiments is provided to enable any person skilled in the art to make or use such embodiments. Various modifications to these embodiments will be readily apparent to those skilled in the art, and the generic principles defined herein may be applied to other embodiments without departing from the spirit or scope of the invention. Thus, the disclosed embodiments are not intended to be limited to the embodiments shown herein, but are to be accorded the widest scope consistent with the following claims and the principles and novel features disclosed herein.

1. A valve apparatus, comprising:
at least four ball valves including a first ball valve, a second ball valve, a third ball valve, and a fourth ball valve, wherein said first, second, third, and fourth ball valves are disposed between a first block and a second block; and
a bleed valve assembly disposed between said first ball valve and said second ball valve, wherein said fourth ball valve is disposed between said second and third ball valves, and wherein said bleed valve assembly is configured for connection to a flex hose.

2. The valve apparatus of claim 1 wherein said bleed valve assembly comprises a globe valve having threads for said connection to said flex hose.

3. The valve apparatus of claim 1 wherein said bleed valve assembly comprises a globe valve having a cam lock connection for said connection to said flex hose.

4. The valve apparatus of claim 1 further comprising a DBB (Double-Block and Bleed) valve assembly that includes said first, second, third, and fourth ball valves.

5. The valve apparatus of claim 1 wherein said fourth ball valve disposed between said second and third ball valves functions as an extra bleed valve.

6. The valve apparatus of claim 1 wherein each of said first, second, third, and fourth ball valves contain at least two ball seals.

7. The valve apparatus of claim 2 further comprising a DBB (Double-Block and Bleed) valve assembly that includes said first, second, third, and fourth ball valves wherein said fourth ball valve disposed between said second and third ball valves functions as an extra bleed valve and wherein each of said first, second, third, and fourth ball valves contain at least two ball seals.

8. The valve apparatus of claim 3 further comprising a DBB (Double-Block and Bleed) valve assembly that includes said first, second, third, and fourth ball valves wherein said fourth ball valve disposed between said second and third ball valves functions as an extra bleed valve and wherein each of said first, second, third, and fourth ball valves contain at least two ball seals.

9. The valve apparatus of claim 1 further comprising at least one gasket inserted between a valve and piping flanges to provide a tight seal.

10. A valve apparatus, comprising:
a first block and a second block;
at least four ball valves including a first ball valve, a second ball valve, a third ball valve, and a fourth ball valve, wherein said first, second, third, and fourth ball valves are disposed between said first and second blocks; and
a bleed valve assembly disposed between said first ball valve and said second ball valve, wherein said fourth ball valve is disposed between said second and third ball valves, and wherein said bleed valve assembly is configured with threads for connection to a flex hose.

11. The valve apparatus of claim 10 further comprising a DBB (Double-Block and Bleed) valve assembly that includes said first, second, third, and fourth ball valves.

12. The valve apparatus of claim 10 wherein said fourth ball valve disposed between said second and third ball valves functions as an extra bleed valve.

13. The valve apparatus of claim 10 wherein each of said first, second, third, and fourth ball valves contain at least two ball seals.

14. The valve apparatus of claim 10 further comprising at least one gasket inserted between a valve and piping flanges to provide a tight seal.

15. The valve apparatus of claim 10 further comprising a DBB (Double-Block and Bleed) valve assembly that includes said first, second, third, and fourth ball valves wherein said fourth ball valve disposed between said second and third ball valves functions as an extra bleed valve and wherein each of said first, second, third, and fourth ball valves contain at least two ball seals.

16. A valve apparatus, comprising:
a first block and a second block;
at least four ball valves including a first ball valve, a second ball valve, a third ball valve, and a fourth ball valve, wherein said first, second, third, and fourth ball valves are disposed between said first and second blocks; and
a bleed valve assembly disposed between said first ball valve and said second ball valve, wherein said fourth ball valve is disposed between said second and third ball valves, and wherein said bleed valve assembly is configured with a cam lock for connection to a flex hose.

17. The valve apparatus of claim 16 further comprising a DBB (Double-Block and Bleed) valve assembly that includes said first, second, third, and fourth ball valves.

18. The valve apparatus of claim 16 wherein said fourth ball valve disposed between said second and third ball valves functions as an extra bleed valve.

19. The valve apparatus of claim 16 wherein each of said first, second, third, and fourth ball valves contain at least two ball seals.

20. The valve apparatus of claim 16 further comprising at least one gasket inserted between a valve and piping flanges to provide a tight seal.
